(19) United States
(12) Patent Application Publication
(10) Pub. No.: US 2015/0160762 A1
(43) Pub. Date: Jun. 11, 2015

(54) CONTROL-POINT SENSING PANEL

(71) Applicant: Touchplus Information Corp., New Taipei City (TW)

(72) Inventor: SHIH-HSIEN HU, NEW TAIPEI CITY (TW)

(21) Appl. No.: 14/567,097

(22) Filed: Dec. 11, 2014

Related U.S. Application Data
(63) Continuation-in-part of application No. 14/162,004, filed on Jan. 23, 2014.

(30) Foreign Application Priority Data
Dec. 11, 2013 (TW) 102145721

(51) Int. Cl. G06F 3/044; G06F 17/50

(52) U.S. Cl. CPC G06F 3/044; G06F 17/5081; G06F 2203/04112; G06F 2203/04111

(57) ABSTRACT

Once size of the substrate of a control-point sensing panel and tip width of a control object are given, an electrode layout structure can be acquired. The electrode layout structure includes M*N first sensing electrodes; M*N second sensing electrodes; a first signal input/output terminal set including M signal input/output terminals, each being electrically connected to N first sensing electrodes in parallel; and a second signal input/output terminal set including N signal input/output terminals, each being electrically connected to M second sensing electrodes in series. The first and second sensing electrodes are formed on the same plane, and form M*N electrode juxtaposition zones in M*N sensing cells at intersections. Each the electrode juxtaposition zone has width being 0.5˜4.5 times the tip width of the control object, and/or clearance between adjacent ones of the electrode juxtaposition zones is 0.5˜1.5 times the tip width of the control object.

### CROSS-REFERENCE TO RELATED APPLICATIONS

The present application is a continuation-in-part application claiming benefit from a U.S. Patent Application bearing a Ser. No. 14/162,004 and filed Jan. 23, 2014, contents of which are incorporated herein for reference.

### FIELD OF THE INVENTION

The present invention relates to a control-point sensing panel, and more particularly to a two-dimensional control-point sensing panel. The present invention also relates to a design method of a control-point sensing panel.

### BACKGROUND OF THE INVENTION

Based on working principles, commercially available touch panels are generally classified into resistive-type touch panels and capacitive-type touch panels. When a user touches or approaches the surface of the capacitive-type touch panel with his finger or a control object, the capacitance of the capacitive-type touch panel changes accordingly. A touch position can be located by sensing and calculating the capacitance change. A conventional two-dimensional capacitive-sensing touch panel is mainly constituted of two sets of sensing pads respectively arranged horizontally and vertically, and the two sets of sensing pads are isolated at their intersected parts with insulating material so that capacitors are formed. A two-dimensional capacitive-sensing touch panel is a mainstream among current capacitive-sensing touch panels because it can detect multiple touch points at the same time so as to meet the demand on multipoint touch sensing in the market.

Since capacitors of the conventional two-dimensional capacitive-sensing touch panel are formed by isolating the two sets of sensing pads with insulating material at the intersections of the two sets of sensing pads, complex procedures are involved, and thus relatively high cost would be inevitable. Furthermore, since it is necessary to increase the amount of sensing pads and decrease areas of the sensing pads in order to improve the sensing resolution of the conventional two-dimensional type capacitive-sensing touch panel, a large amount of sensing pins would be required for a driving circuit, and thus the hardware cost would increase.

### SUMMARY OF THE INVENTION

Therefore, an object of the present invention is to pursue high performance without increasing cost.

In an aspect of the present invention, a control-point sensing panel for sensing a control point thereon in response to an action of a control object comprises: a substrate; M*N first sensing electrodes formed on a surface of the substrate; a first signal input/output terminal set including M signal input/output terminals, each of which is at least electrically connected to N of the first sensing electrodes in parallel; M*N second sensing electrodes formed on the surface of the substrate; and a second signal input/output terminal set including N signal input/output terminals, each of which is at least electrically connected to M of the second sensing electrodes; wherein the first sensing electrodes and the second sensing electrodes are formed on the same plane, and form M*N electrode juxtaposition zones at intersections of the first and second sensing electrodes, and each of the electrode juxtaposition zones has a width being 0.5˜4.5 times the tip width of the control object.

In an embodiment, the sensing panel further comprises N sets of M signal lines, wherein the M signal lines in each set respectively coupled to the M first sensing electrodes in the same column, and the N signal lines, each selected from one of the N sets and corresponding to one of the N first sensing electrodes in the same row, are electrically connected in parallel to a corresponding one of the M signal input/out terminals in the first signal input/output terminal set.

In an embodiment, the N sets of signal lines pass through respective columns of wiring zones, each of which is disposed between adjacent two of the electrode juxtaposition zones.

In an embodiment, the sensing panel further comprises a non-wiring region where dummy transparent wires are formed.

In an embodiment, the first sensing electrode and the second sensing electrode respectively include a plurality of sub-electrodes, and the sub-electrodes of the first sensing electrode and the sub-electrodes of the second sensing electrode are coplanar and alternately allocated in the electrode juxtaposition zones.

In an embodiment, at least one of the electrode juxtaposition zones has a width smaller than the tip width of the control object, and the effective area of the sub-electrodes of the first sensing electrode or the second sensing electrode decreases along a specified direction.

In another aspect of the present invention, a control-point sensing panel for sensing a control point thereon in response to an action of a control object comprises: a substrate defined thereon M*N sensing cells; M*N first sensing electrodes formed on a surface of the substrate; a first signal input/output terminal set including M signal input/output terminals, each of which is at least electrically connected to N of the first sensing electrodes in parallel; M*N second sensing electrodes formed on the surface of the substrate; and a second signal input/output terminal set including N signal input/output terminals, each of which is at least electrically connected to M of the second sensing electrodes in series; wherein the first sensing electrodes and the second sensing electrodes are formed on the same plane, and form M*N electrode juxtaposition zones in the M*N sensing cells at intersections of the first and second sensing electrodes, respectively, and each of the electrode juxtaposition zones has an area being ⅓˜½ times the area of the corresponding sensing cell.

In a further aspect of the present invention, a control-point sensing panel for sensing a control point thereon in response to an action of a control object comprises a substrate; M*N first sensing electrodes formed on a surface of the substrate; a first signal input/output terminal set including M signal input/output terminals, each of which is at least electrically connected to N of the first sensing electrodes in parallel; M*N second sensing electrodes formed on the surface of the substrate; and a second signal input/output terminal set including N signal input/output terminals, each of which is at least electrically connected to M of the second sensing electrodes in series; wherein the first sensing electrodes and the second sensing electrodes are formed on the same plane, and form M*N electrode juxtaposition zones at intersections of the first and second sensing electrodes, and a clearance between every two adjacent ones of the electrode juxtaposition zones is 0.5˜1.5 times the tip width of the control object.

A yet further aspect of the present invention relates to a design method of a control-point sensing panel executable by a digital data processing device to define an electrode layout structure. The control-point sensing panel is used for sensing a control point thereon in response to an action of a control object. The method comprises: inputting a size of a substrate where the electrode layout structure is to be formed, and a tip width of the control object; and acquiring the electrode layout structure according to the size of the substrate and the tip width of the control object, wherein the electrode layout structure includes M*N first sensing electrodes; M*N second sensing electrodes; a first signal input/output terminal set including M signal input/output terminals, each of which is at least electrically connected to N of the first sensing electrodes in parallel; and a second signal input/output terminal set including N signal input/output terminals, each of which is at least electrically connected to M of the second sensing electrodes in series. The first sensing electrodes and the second sensing electrodes are formed on the same plane, and form M*N electrode juxtaposition zones in M*N sensing cells at intersections of the first and second sensing electrodes, respectively.

Preferably, each of the electrode juxtaposition zones has a width being 0.5˜4.5 times the tip width of the control object, and/or a clearance between every two adjacent ones of the electrode juxtaposition zones is 0.5˜1.5 times the tip width of the control object and/or each of the electrode juxtaposition zones has an area being ⅓˜½ times the area of the corresponding sensing cell.

It is to be noted that the term “intersections” does not specifically mean that the first and second sensing electrodes are physically connected to each other but principally indicates that the first and second sensing electrodes are close enough to each other there.

### BRIEF DESCRIPTION OF THE DRAWINGS

The invention will become more readily apparent to those ordinarily skilled in the art after reviewing the following detailed description and accompanying drawings, in which:

FIG. 1A is a schematic functional block diagram showing a two-dimensional control-point sensing panel;

FIG. 1B is a schematic circuit diagram showing coupling capacitance generated when a finger approaches a signal transmitting line and a signal receiving line of a two-dimensional control-point sensing panel;

FIG. 2A is a schematic diagram showing sensing cells of a control-point sensing panel according to an embodiment of the present invention;

FIG. 2B and 2C are schematic diagrams showing layout examples of corner sensing cells of a control-point sensing panel according to an embodiment of the present invention;

FIGS. 3A-3C are portions of a flowchart combined to show control-point sensing steps executed by a control-point sensing panel according to an embodiment of the present invention;

FIG. 4A is a schematic diagram showing a portion of a circuit structure of a control-point sensing panel according to an embodiment of the present invention;

FIG. 4B is a waveform diagram showing signals associated with the control-point sensing performed by a control-point sensing panel according to an embodiment of the present invention;

FIGS. 5A-5D are schematic diagrams showing examples of characteristic value arrays generated during control-point sensing;

FIG. 6 is a functional block diagram schematically showing an exemplified use of multiple chips for controlling a single control-point sensing panel according to an embodiment of the present invention;

FIG. 7 is a functional block diagram schematically showing another exemplified use of multiple chips for controlling a single control-point sensing panel according to an embodiment of the present invention; and

FIG. 8 is a functional block diagram schematically showing a further exemplified use of multiple chips for controlling a single control-point sensing panel according to an embodiment of the present invention;

FIG. 9 is a schematic diagram showing a comparator circuit according to another embodiment of the present invention, replacing the comparator circuit shown in FIG. 1A;

FIG. 10 is a schematic diagram showing an exemplified configuration of an electrode juxtaposition zone in a sensing cell of a control-point sensing panel according to an embodiment of the present invention;

FIG. 11 is a schematic diagram showing the distribution of an electrode juxtaposition zone in a sensing cell of a control-point sensing panel according to an embodiment of the present invention; and

FIG. 12A and 12B are schematic diagrams showing further layout examples of corner sensing cells of a control-point sensing panel according to an embodiment of the present invention.

### DETAILED DESCRIPTION OF PREFERRED EMBODIMENTS

The invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

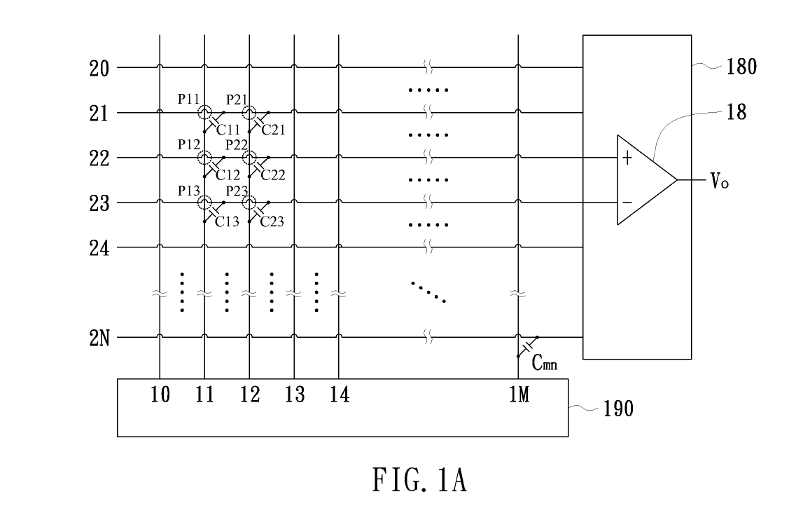

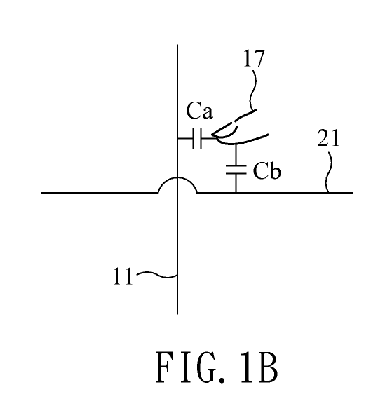

Please refer to FIG. 1A, in which a two-dimensional control-point sensing panel is schematically illustrated, wherein M signal transmitting lines 11˜1M and N signal receiving lines 21˜2N are allocated, and M*N electrode juxtaposition zones P11˜Pmn are formed. In response to the proximity or touch of a user's finger 17 or any other control object onto a specified one of the electrode juxtaposition zones P11˜Pmn, as shown in FIG. 1B, respective coupling capacitance Ca and Cb in the signal transmitting line 11 and the signal receiving line 21 associated with the specified electrode juxtaposition zone would vary. By detecting capacitance variation occurring on the sensing panel, control point or points can be located. It is to be noted that although the vertical and horizontal lines are schematically shown to have crossover intersections, they are not limited to have such configurations. Instead, they are in juxtaposition configurations, i.e. the electrodes are substantially coplanar, in the embodiments of the present invention. The configurations will be described in detail hereinafter.

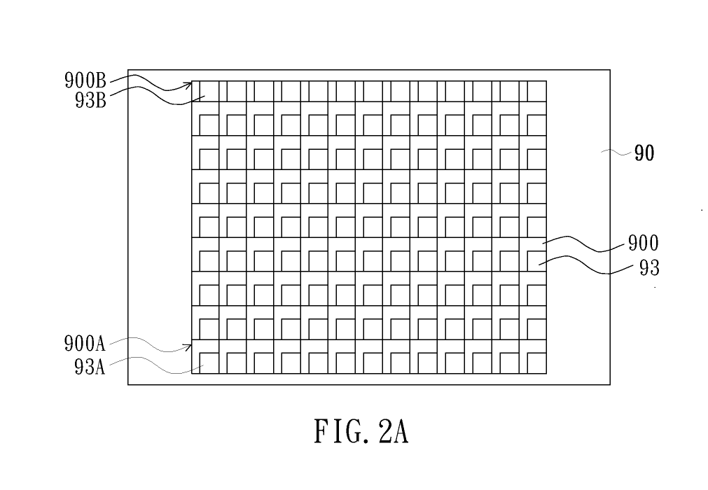

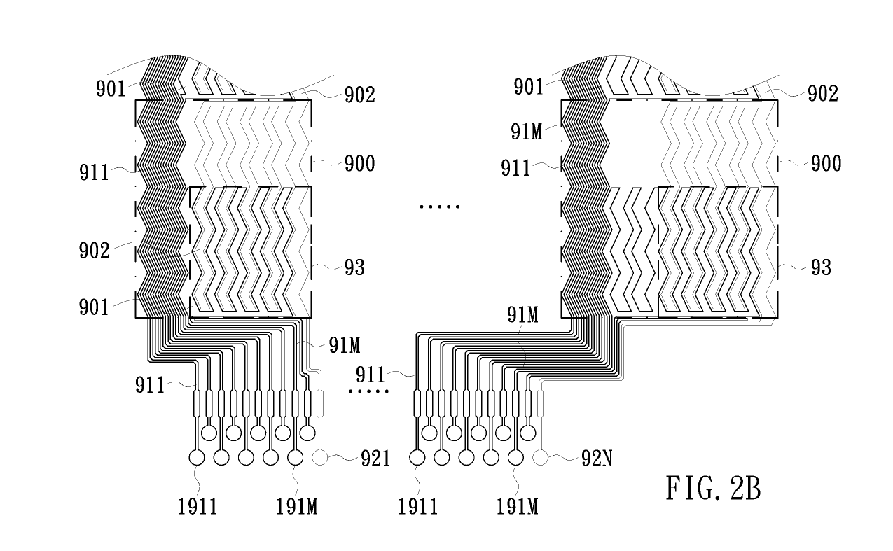

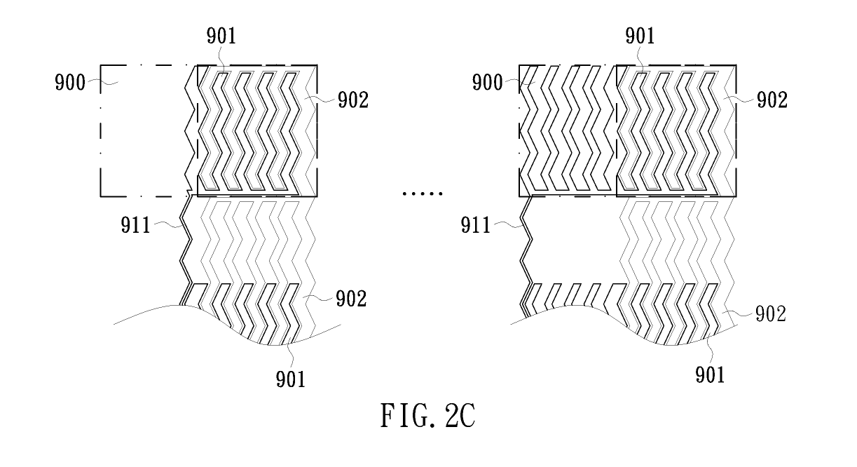

An electrode layout structure of the control-point sensing panel according to an embodiment of the present invention is schematically illustrated in FIG. 2A. As shown, a matrix of M*N sensing cells 900 are formed on a substrate 90, e.g. M=9 and N=14, and M*N electrode juxtaposition zones 93 are respectively allocated inside the M*N sensing cells 900. Preferably but not necessarily, the area of each electrode juxtaposition zone 93 occupies ⅓ to ½ of the area of the corresponding sensing cell 900. The details of the layouts of selected sensing cells 900 are schematically shown in FIGS. 2B and 2C.

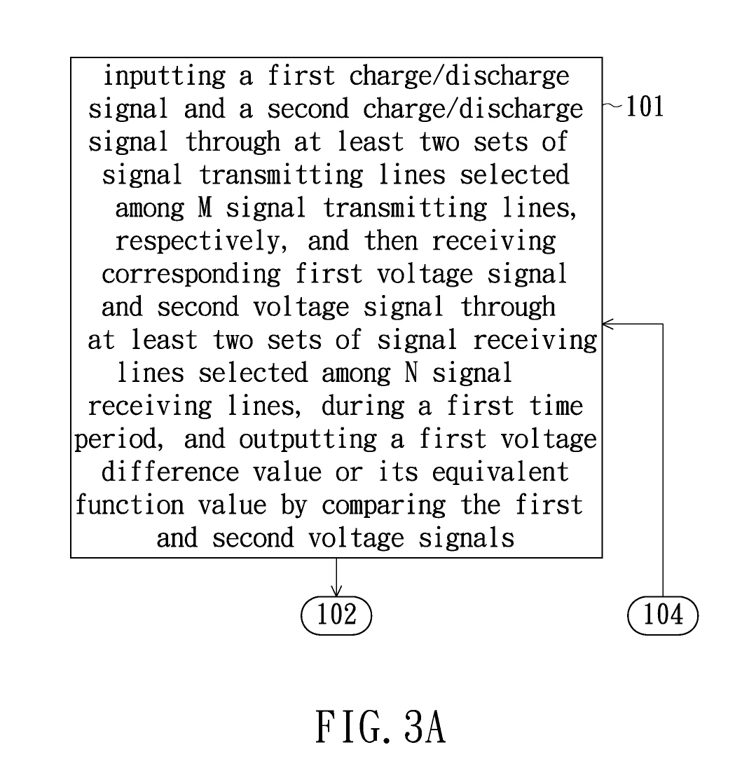

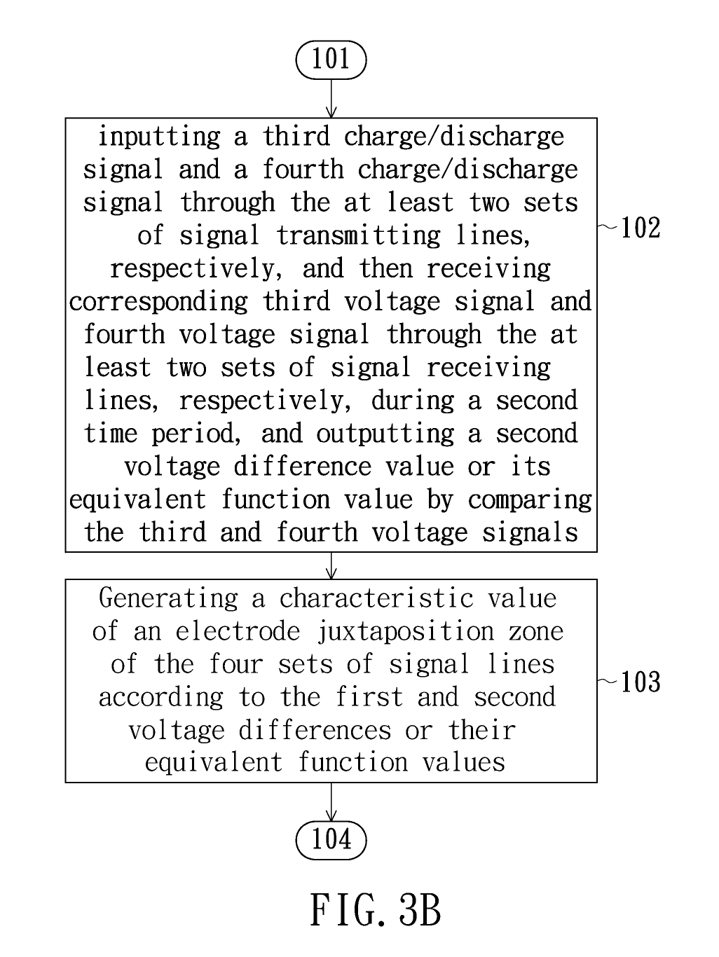

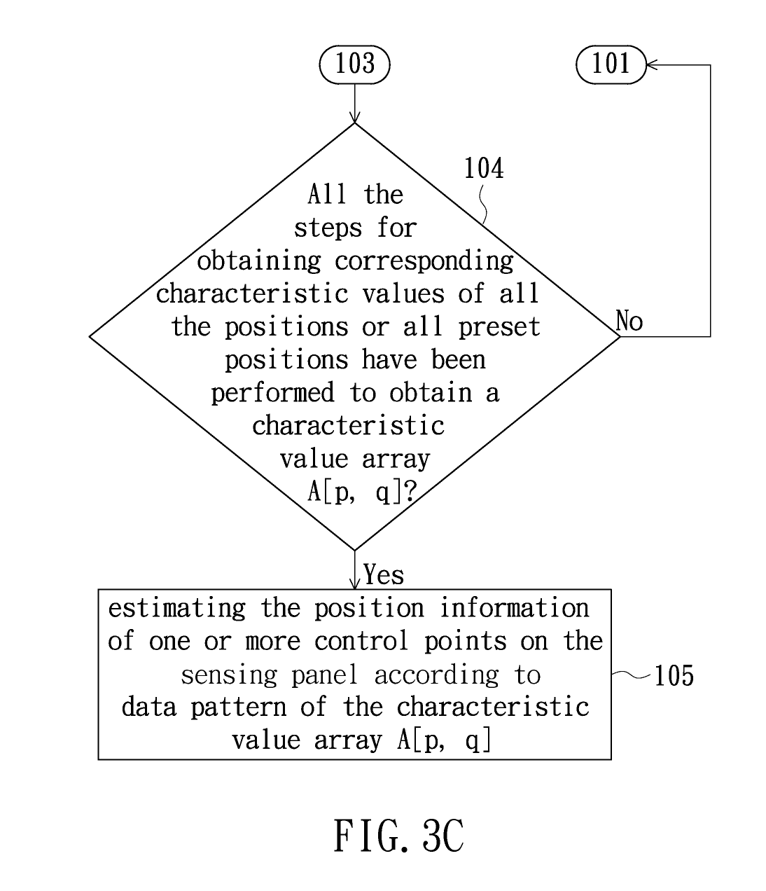

Please refer to FIG. 2B, which exemplifies the electrode layout structure of the sensing cells 900A in the bottom row and the electrode juxtaposition zones 93A disposed in corresponding sensing cells 900A. Since the configuration of the sensing cells 900A are basically repetitive, so only two corner sensing cells 900A are shown in detail while denoting the omitted sensing cells with dots. As shown, first sensing electrodes 901 and second sensing electrodes 902 coexist alternately in the electrode juxtaposition zone 93A. M signal lines 911˜91M are coupled to the M first sensing electrodes 901 in the same column, respectively, and constitutes a signal set. On the other hand, although not shown in the figure, it is understood that there should be N such signal sets as there are N columns of sensing cells. By electrically connecting a group of the N signal lines, which are respectively coupled to the N first sensing electrodes 901 in the same row, to a common signal input/output terminal, the first sensing electrodes 901 in the same row can be interconnected. For example, all the signal lines 911 coupled to the first row of first sensing electrodes 901 are electrically connected to the common signal input/output terminal 1911 in parallel, and thus the first sensing electrodes 901 in the first row are electrically interconnected. Furthermore, the M sensing cells 900 in each same column are electrically interconnected with the second sensing electrode 902 extending through the sensing cells 900 in the same column to a common signal input/output terminal 921˜92N. It is to be noted that the sensing cells 900A are repetitive means that the sensing cells 900A have similar electrode juxtaposition zones 93A and wiring structures, but the area of the sensing cells 900A, as well as the numbers of sub-electrodes of the first sensing electrode 901 and second sensing electrode 902, may be different for practical requirement. For example, in the example as shown in FIG. 3B, the right sensing cell is larger than the left one, and the first sensing electrode 901 has more sub-electrodes than the second sensing electrode 902. The repetitive sensing cells disposed therebetween may be like the left one or like the right one or otherwise designed. Likewise, FIG. 2C can be referred to realize examples of the electrode layout structure of the sensing cells 900B in the top row and the electrode juxtaposition zones 93B disposed in corresponding sensing cells 900B.

The signal lines and signal input/output terminals may both formed on the substrate 90, e.g. glass substrate. Alternatively, it is also feasible to have the signal lines extend outside the substrate, for example to a printed circuit board where the signal input/output terminals are formed. The design is flexible to comply with practical requirement.

The control-point sensing method executed by the above-described control-point sensing panel will be described hereinafter. The matrix of sensing cells of the control-point sensing panel are electrically connected to a voltage signal processor 180 and a charge/discharge signal generator 190 (see FIG. 1A). The control-point sensing method is briefly illustrated with reference to the flowchart of FIGS. 3A˜3C.

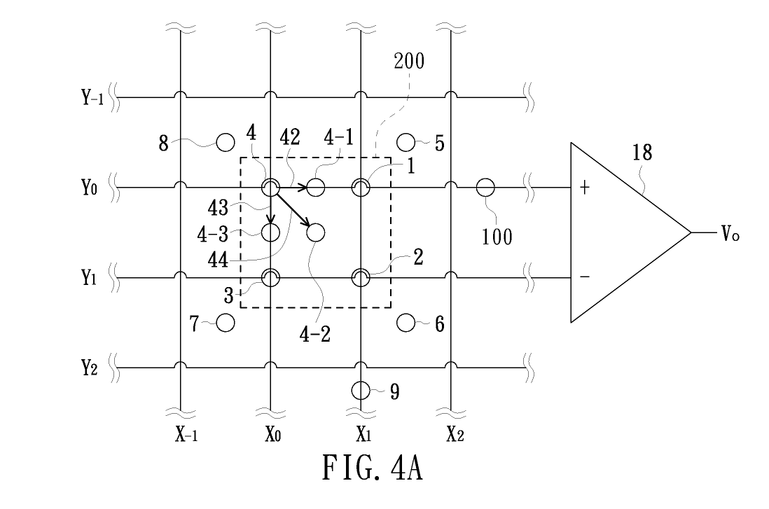

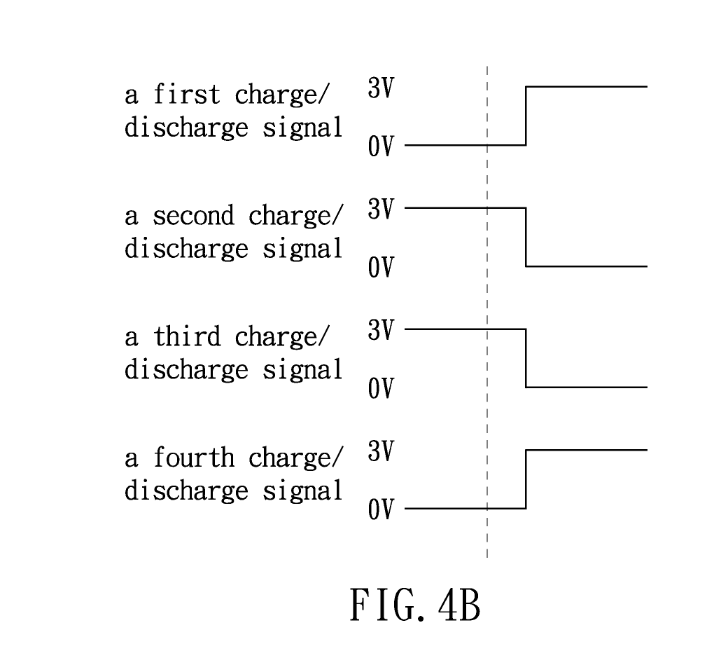

In Step 101, the charge/discharge signal generator 190 has a first charge/discharge signal and a second charge/discharge signal respectively inputted through at least two sets of signal transmitting lines selected among the M signal transmitting lines 11˜1M and then the voltage signal processor 180 receives a first voltage signal and a second voltage signal, which are generated corresponding to the first charge/discharge signal and the second charge/discharge signal, respectively, through at least two sets of signal receiving lines selected among N signal receiving lines during a first time period. For example, the two sets of signal transmitting lines can be adjacent signal transmitting lines 12, 13, while the two sets of signal receiving lines can be adjacent two signal receiving lines 22, 23. The first charge/discharge signal can be a charge signal rising from 0V to 3V (refer to FIG. 4B), the second charge/discharge signal can be a discharge signal falling from 3V to 0V (refer to FIG. 4B). The first voltage signal and the second voltage signal respectively received from the adjacent two signal receiving lines 22, 23 are compared in a comparator circuit 18 shown in FIG. 1A and then a first voltage difference value or a function value equivalent to the first voltage difference value is outputted via an output terminal Vo according to the comparison result of the first voltage signal and the second voltage signal. For example, a function value with the same polarity but nonlinear to the first voltage difference value can be obtained by a different comparing method or circuit; or functions of the first voltage difference value and the second voltage difference value can be obtained by adjusting the level of the charge/discharge signal. The details will be described below.

Next, in Step 102, the charge/discharge signal generator 190 has a third charge/discharge signal and a fourth charge/discharge signal respectively inputted through the same sets of signal transmitting lines, and then the voltage signal processor 180 receives corresponding third voltage signal and fourth voltage signal respectively through the same sets of signal receiving lines during a second time period. That is, the two sets of signal transmitting lines are the adjacent signal transmitting lines 12, 13, while the two sets of signal receiving lines are the adjacent two signal receiving lines 22, 23. In this step, the third charge/discharge signal is a discharge signal falling from 3V to 0V (refer to FIG. 4B), while the fourth charge/discharge signal is a charge signal rising from 0V to 3V (refer to FIG. 4B), and the third voltage signal and the fourth voltage signal respectively received from the adjacent two signal receiving lines 22, 23 are compared in the comparator circuit 18 shown in FIG. 1A so as to output a second voltage difference value or a function value equivalent to the second voltage difference value via the output terminal Vo according to the comparison result of the third voltage signal and the fourth voltage signal. For example, a function value with the same polarity but nonlinear to the second voltage difference value can be obtained by a different comparing method or circuit; or functions of the third voltage difference value and the fourth voltage difference value can be obtained by adjusting the level of the charge/discharge signal. The details will be described below.

Next, in Step 103, the voltage signal processor 180 generates a characteristic value of a selected one of the electrode juxtaposition zones defined by the four sets of signal lines according to the first voltage difference value or its equivalent function value and the second voltage difference value or its equivalent function value. For example, the characteristic value of the selected electrode juxtaposition zone defined by the adjacent signal transmitting lines 12, 13 and the adjacent signal receiving lines 22, 23 is generated. For example, the characteristic value of the electrode juxtaposition zone P22 can be defined as the difference obtained by subtracting the second voltage difference value or its function value from the first voltage difference value or its function value. The characteristic value associated with the selected electrode juxtaposition zone would correlate to the coupling capacitance generated when a finger or a control object touches or approaches the signal transmitting line and the signal receiving line defining the selected electrode juxtaposition zone.

The voltage signal processor 180 repeats the above-mentioned steps 101˜103 for all the other sets of signal transmitting lines and all the other sets of signal receiving lines, e.g. adjacent signal transmitting lines and the adjacent signal receiving lines, to generate a plurality of characteristic values, thereby obtaining a characteristic value array A[p, q]. Afterwards, the characteristic value array A[p, q] can be used to estimate position information of one or more control points on the control-point sensing panel in a subsequent step, wherein each control point is a position to which a finger or other control object approaches on the sensing panel. When it is determined that all the required steps for obtaining corresponding characteristic values of all the positions or all preset positions have been performed in Step 104, then the method proceeds to Step 105.

In Step 105, the position information of one or more control points on the sensing panel are estimated according to data pattern of the characteristic value array A[p, q]. The control point is a position to which a finger or other control object touches or approaches on the capacitive-type panel. Step 105 can be performed in a control circuit chip, which includes the voltage signal processor 180, of the sensing panel. Alternatively, the characteristic value array A[p, q] can be transmitted to an information processing system where the sensing panel is applied, for example, a notebook computer, a tablet computer etc. In this example, Step 105 is executed in the information processing system. The details of the above-mentioned technology will be described hereinafter with reference to FIGS. 4A and 4B, in which a circuit structure and a signal waveform are schematically shown. However, the implementation of the invention is not limited to the following examples. Since in the above-mentioned embodiment a unit to be sensed involve adjacent two signal transmitting lines and adjacent two signal receiving lines, a window 200 covering electrode juxtaposition zones defined by four signal lines, e.g. adjacent two signal transmitting lines and adjacent two signal receiving lines, can be moved, as a whole, over the sensing panel for scanning When the window 200 is moved to the selected electrode juxtaposition zone defined by the signal lines X₀, X₁, Y₀, Y₁, and a relative position of an approaching or contact point of a finger (or a conductor) to the window 200 is substantially an upper right intersection 1 of the signal lines X₁ and Y₀, the first voltage difference value and second voltage difference value obtained through steps 101 and 102 will be +ΔV and −ΔV, respectively. Accordingly, the characteristic value obtained in step 103, i.e. subtracting the second voltage difference value from the first voltage difference value, will be +2ΔV. In another case that the relative position of an approaching or contact point of a finger (or a conductor) to the window 200 is substantially a lower right intersection 2 of the signal lines X₁ and Y₁, the first voltage difference value and second voltage difference value obtained through steps 101 and 102 will be −ΔV and +ΔV, respectively. Accordingly, the characteristic value obtained in step 103, i.e. subtracting the second voltage difference value from the first voltage difference value, will be 31 2ΔV. Alternatively, if a relative position of an approaching or contact point of a finger (or a conductor) to the window 200 is substantially a lower left intersection 3 of the signal lines X₀ and Y₁, the first voltage difference value and second voltage difference value obtained through steps 101 and 102 will be +ΔV and −ΔV, respectively. Accordingly, the characteristic value obtained in step 103, i.e. subtracting the second voltage difference value from the first voltage difference value, will be +2ΔV. Likewise, in the case that a relative position of an approaching or contact point of a finger (or a conductor) to the window 200 is substantially an upper left intersection 4 of the signal lines X₀ and Y₀, the first voltage difference value and second voltage difference value obtained through steps 101 and 102 will be −ΔV and +ΔV, respectively. Accordingly, the characteristic value obtained in Step 103, i.e. subtracting the second voltage difference value from the first voltage difference value, will be −2ΔV. On the other hand, when a finger (or a conductor) approaches or contacts the window 200 substantially at a position 5, 6, 7 or 8 shown in FIG. 4A, i.e. a position outside the window 200, the characteristic value obtained through Steps 101˜103 in each case will have the same polarity with the corresponding position 1, 2, 3, or 4 but a smaller absolute value.

Furthermore, if a finger (or a conductor) approaches or contacts the window 200 substantially at a position 9 as shown in FIG. 4A, the first voltage difference value obtained in Step 101 and the second voltage difference value obtained in Step 102 will both be 0 on a condition that the charge/discharge signal on the signal transmitting line is strong enough. Accordingly, the characteristic value obtained by subtracting the second voltage difference value from the first voltage difference value in Step 103 will be 0. In a further example that a finger (or a conductor) approaches or contacts the window 200 substantially at a position 100 as shown in FIG. 4A, since the first voltage difference value obtained in Step 101 and the second voltage difference value obtained in Step 102 are respectively −ΔV and −ΔV, the characteristic value obtained by subtracting the second voltage difference value from the first voltage difference value in Step 103 will be 0. In this case that the window 200 is located at the electrode juxtaposition zones defined by the signal lines X₀, X₁, Y₀, Y₁, if there is no finger (nor conductor) approaching or contacting the panel, or a relative position of an approaching or contacting point of the finger (or conductor) to the window 200 is substantially at a position (4-1), a position (4-2) or a position (4-3), a characteristic value obtained through Steps 101˜103 will be 0. In this way, after the whole sensing panel is scanned with the window 200 defined with 2*2 signal lines, a characteristic value array A[p, q] is generated, in which characteristic values obtained in the above-mentioned steps and corresponding to specified positions of the window are stored. The characteristic values can be positive, negative or 0, for example simply represented by +, − and 0.

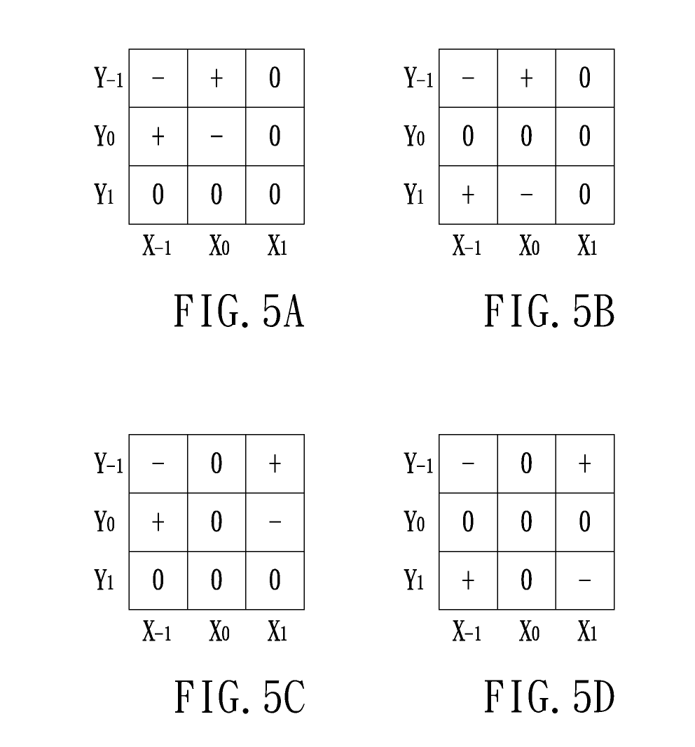

An analysis is then performed according to the data pattern of the characteristic value array A[p, q]. Position information of one or more control point on the sensing panel can be estimated in Step 104. The control point is a position which a finger approaches or contacts on the sensing panel. For example, if there is no finger approaching or contacting the sensing panel, all of the data recorded into the characteristic value array A[p, q] as obtained in the scanning steps during a preset time period are 0. On the other hand, if a finger is approaching or contacting an a common region defined by a signal transmitting line and a signal receiving line, e.g. the electrode juxtaposition zone defined by X₀ and Y₀, of the sensing panel, the characteristic value corresponding to the specified position and eight characteristic values corresponding to eight surrounding positions form a 3*3 data array, e.g. the array as shown in FIG. 4A. Therefore, by performing an operation on a 3*3 data array, the position which a finger approaches or contacts on the sensing panel can be specified. For example, when the result of the operation meets a first pattern, e.g. the pattern as shown in FIG. 5A, it is determined that the estimated control point is (X₀, Y₀) and an offset vector associated with the control point is (X₀, Y₀) is 0. That is, when the characteristic value array A[p, q] includes a data pattern as shown in FIG. 5A, it is realized that there is a control point at (X₀, Y₀). If the characteristic value array A[p, q] includes more than one data pattern like the one shown in FIG. 5A with zero offset, it is realized that there exists another control point at a specific intersection of a signal transmitting line and a signal receiving line.

In addition, when a part of the characteristic value array A[p, q] has a data pattern as shown in any one of FIGS. 5B-5D, it is also estimated that there exists one control point. The control point is not at the intersection but nearby the intersection (X₀, Y₀) with a second offset vector 42, a third offset vector 43, or a fourth offset vector 44. For example, the data pattern shown in FIG. 5B indicates that a control point is below the intersection (X₀, Y₀) (for example, the position (4-3) shown in FIG. 4A), the data pattern shown in FIG. 5C indicates that a control point is at right side of the intersection (X₀, Y₀) (for example, the position (4-1) shown in FIG. 3), and the data pattern shown in FIG. 5D indicates that a control point is at lower right of the intersection (X₀, Y₀) (for example, the position (4-2) shown in FIG. 4A). Therefore, at the same wiring density, the resolution of the invention can be increased to two times at two dimensions, and thus the overall resolution can be increased to four times.

The examples of the charge/discharge signals shown in FIG. 4B are only for description, it is not limited to a signal falling from 3V to 0V or a signal rising from 0V to 3V. The object of sensing can be achieved by using any signal that falls from a larger fixed voltage to a smaller fixed voltage or rises from another smaller fixed voltage to another larger fixed voltage. The signals for sensing are set to be 0V and 3V for the purpose to maintain a balance of the circuit design.

Since the position detection is performed with two adjacent signal transmitting lines and two adjacent signal receiving lines, it is necessary to provide dummy signal lines 10, 20 as shown in FIG. 1 at each edge of the X-direction and Y-direction of the sensing panel, so as to perform the above-mentioned operation to the signal transmitting line 11 and the signal receiving line 21. However, it is not necessary to provide a capacitor to the dummy signal line. Of course, it is also possible to omit the dummy signal line, and directly mirror the signal transmitting line 12 and the signal receiving line 22 to be virtual dummy signal lines 10, 20, so as to perform the above-mentioned operation to the signal transmitting line 11 and the signal receiving line 21.

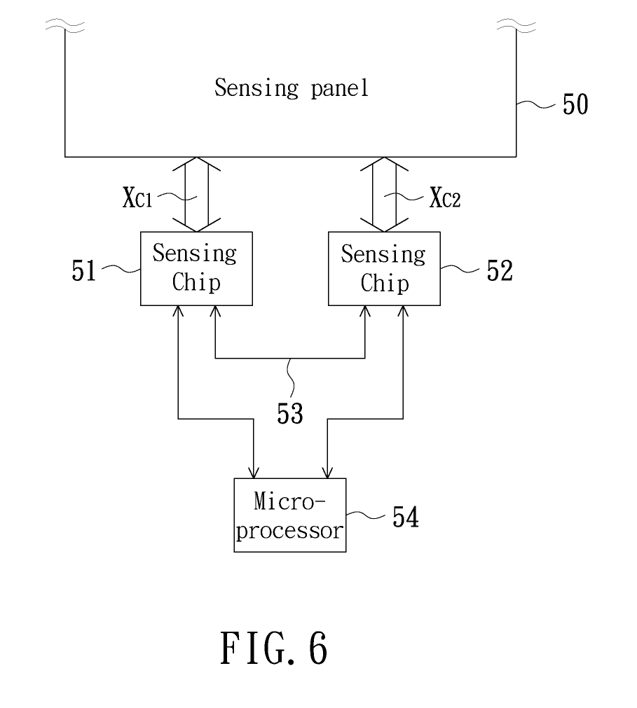

Further, please refer to FIG. 6, which is a functional block diagram schematically showing an exemplified use of the invention in more than one sensing chip to control the same sensing panel 50. In FIG. 6, two sensing chips are used as an example, different sets of signal transmitting or receiving lines Xc1, Xc2 are processed by different sensing chips 51, 52, and a reference voltage transmission line 53 is disposed between the sensing chips 51, 52 so as to transmit a reference voltage signal to all sensing chips as a reference. By this way, when performing comparison operation to voltage signals, which are generated by the signal receiving lines belonging to different sensing chips, a consistent reference voltage is provided. The voltage difference values obtained in steps 101, 102 or the characteristic value obtained in step 103 can be transmitted by the sensing chips 51, 52 to a microprocessor 54 at back-end, so that corresponding position information of a control point can be obtained. Thus, a major object of the invention can be achieved.

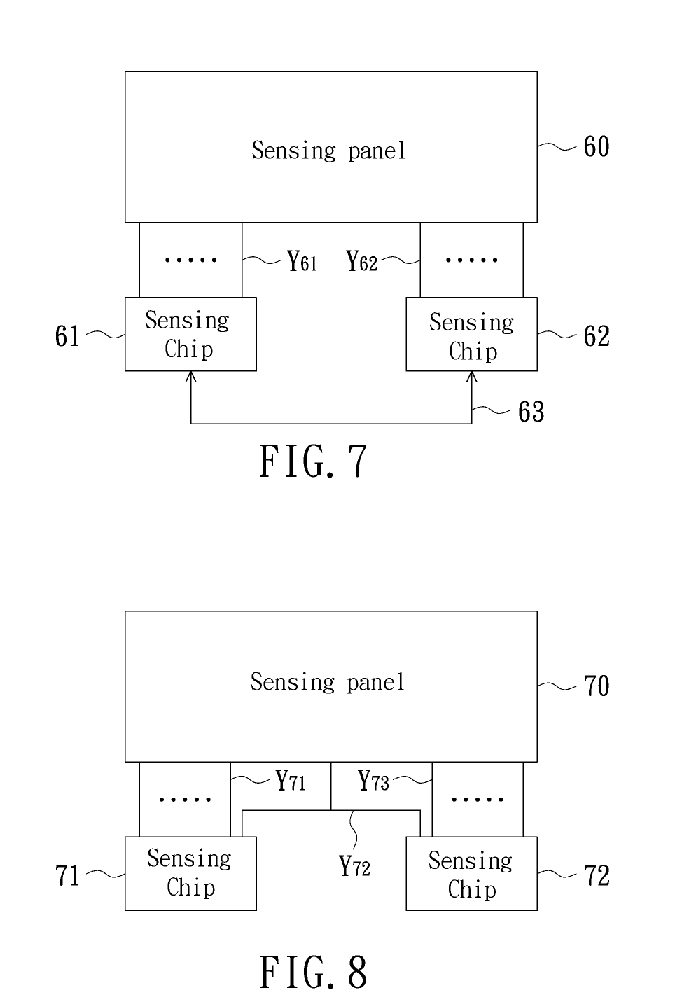

In addition, please refer to FIG. 7, if adjacent signal receiving lines Y61, Y62 in a sensing panel 60 belong to different chips 61, 62, a signal transmission line (for example, a transmission line 63 in FIG. 7) interconnecting the chips 61, 62 with each other can be used to transmit a voltage signal from adjacent one or more signal line to the other chip as a reference. By this way, the above-mentioned operation can be completed and thus a major object of the invention can be achieved. On the other way, as shown in FIG. 8, a signal receiving line Y72 between signal receiving lines Y71 and Y73 on a sensing panel 70 is connected to different chips 71, 72, so that a voltage signal from the signal receiving line Y72 can be referenced by both chips 71, 72. By this way, the above-mentioned operation can also be completed and thus a major object of the invention can be achieved.

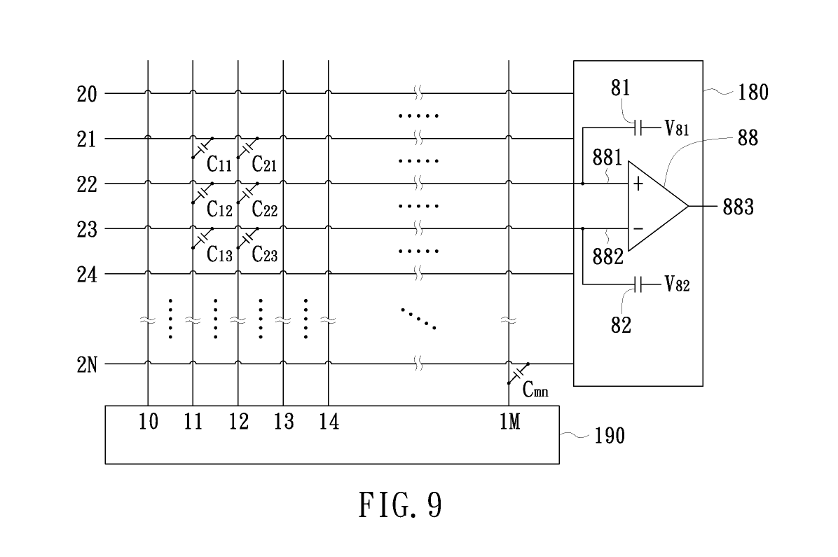

The matrix of sensing cells 900 of the control-point sensing panel may alternatively work with another example of the voltage signal processor 180, as illustrated in FIG. 9. In this embodiment, a first capacitor 81, a second capacitor 82 and the comparator circuit 88 are used to perform another comparing method. In detail, in Step 101, the charge/discharge signal generator 190 the same has a first charge/discharge signal and a second charge/discharge signal respectively inputted through at least two sets of signal transmitting lines selected among the M signal transmitting lines 11˜1M and then the voltage signal processor 180 receives a first voltage signal and a second voltage signal, which are generated corresponding to the first charge/discharge signal and the second charge/discharge signal, respectively, through at least two sets of signal receiving lines selected among N signal receiving lines during a first time period. For example, the two sets of signal transmitting lines can be adjacent signal transmitting lines 12, 13, while the two sets of signal receiving lines can be adjacent two signal receiving lines 22, 23. The first charge/discharge signal can be a charge signal rising from 0V to 3V (refer to FIG. 4B), and the second charge/discharge signal can be a discharge signal falling from 3V to 0V (refer to FIG. 4B). As for the first voltage signal and the second voltage signal respectively received from the adjacent two signal receiving lines 22, 23, two input terminals 881, 882 of the comparator circuit 88 are balanced by controlling levels of an input voltage V81 of the first capacitor 81 and an input voltage V82 of the second capacitor 82 shown in FIG. 9 so that the voltage outputted by an output terminal 883 is maintained at level “0”, and the difference of the levels V81 and V82 when the input terminals 881, 882 are balanced is obtained as the first voltage difference value. Alternatively, by providing the input voltages V81, V82 with the same value but changing the capacitances of the first capacitor 81 and the second capacitor 82 can also balance the two input terminals 881, 882 of the comparator circuit 88 so that the voltage outputted by the output terminal 883 is maintained at level “0”, and the difference of the capacitances of the first capacitor 81 and the second capacitor 82 when the input terminals 881, 882 are balanced is obtained as the function value equivalent to the first voltage difference value. Here, the comparator circuit 18 shown in FIG. 1A needs to be realized by an analog-to-digital converter; however, the comparator circuit 88 can be simply realized by a single-bit comparator.

Further, in Step 102, the charge/discharge signal generator 190 has a third charge/discharge signal and a fourth charge/discharge signal respectively inputted through the two sets of signal transmitting lines and then the voltage signal processor 180 receives a third voltage signal and a fourth voltage signal, which are generated corresponding to the third charge/discharge signal and the fourth charge/discharge signal, respectively, through the two sets of signal receiving line. For example, the two sets of signal transmitting lines can be adjacent signal transmitting lines 12, 13, while the two sets of signal receiving lines can be adjacent two signal receiving lines 22, 23. The third charge/discharge signal can be a discharge signal falling from 3V to 0V (refer to FIG. 4B), and the fourth charge/discharge signal can be a charge signal rising from 0V to 3V (refer to FIG. 4B). As for the third voltage signal and the fourth voltage signal respectively received from the adjacent two signal receiving lines 22, 23, two input terminals 881, 882 of the comparator circuit 88 are balanced by controlling levels of the input voltage V81 of the first capacitor 81 and an input voltage V82 of the second capacitor 82 shown in FIG. 8 so that the voltage outputted by an output terminal 883 is maintained at level “0”, and the difference of the levels V81 and V82 when the input terminals 881, 882 are balanced is obtained as the second voltage difference value. Alternatively, by providing the input voltages V81, V82 with the same value but changing the capacitances of the first capacitor 81 and the second capacitor 82 can also balance the two input terminals 881, 882 of the comparator circuit 88 so that the voltage outputted by the output terminal 883 is maintained at level “0”, and the difference of the capacitances of the first capacitor 81 and the second capacitor 82 when the input terminals 881, 882 are balanced is obtained as the function value equivalent to the second voltage difference value.

In addition, adjacent two signal lines are used as examples for description in the above embodiments. However, in other embodiments of the invention, two sets or more of signal transmitting lines can also be selected from M signal transmitting lines to respectively input a charge/discharge signal, and correspondingly generated voltage signals can be received respectively by two sets or more of signal receiving lines selected from N signal receiving lines. Each set of signal transmitting lines can be consisted of a single signal transmitting line or a plurality of signal transmitting lines, and the two sets of signal transmitting lines can be not adjacent, but with other signal transmitting lines disposed therebetween. Of course, each set of signal receiving lines can also be consisted of a single signal receiving line or a plurality of signal receiving lines, and the two sets of signal receiving lines can be not adjacent, but with other signal receiving lines disposed therebetween. Sensitivity and area for sensing can be increased by using a plurality of signal transmitting lines or a plurality of signal receiving lines to form each set of the signal transmitting lines or signal receiving lines, so that an proximity of a control object without a direct touch to the sensing panel can be sensed. In addition, according to another embodiment of the invention, two sets or more of signal transmitting lines can also be selected from N signal transmitting lines to respectively input a charge/discharge signal, and correspondingly generated voltage signals can be received respectively by two sets or more of signal receiving lines selected from M signal receiving lines. This can be realized by simply using a multiplexer (not shown) to change the line connections. Further, the voltage signal processor 180 can also be constituted by two or more analog/digital converters or a single-bit comparator, and the two or more analog/digital converters can be disposed on different chips. Since this is a common modification of the circuit design, is will not be further described here.

Please refer to FIGS. 2B and 2C again. The first sensing electrodes 901 and the second sensing electrodes 902 in this embodiment are closely and alternately disposed in the electrode juxtaposition zone 93 of each the sensing cell 900, and are substantially coplanar. In this embodiment, the first sensing electrodes 901 and the second sensing electrodes 902 in the electrode juxtaposition zone 93 respectively include a plurality of sub-electrodes configured like combs, and oppositely engaging with each other with proper clearance. In this embodiment, the sub-electrodes of the comb-shaped sensing electrodes are zigzagged along each other so as to improve electrode distribution uniformity.

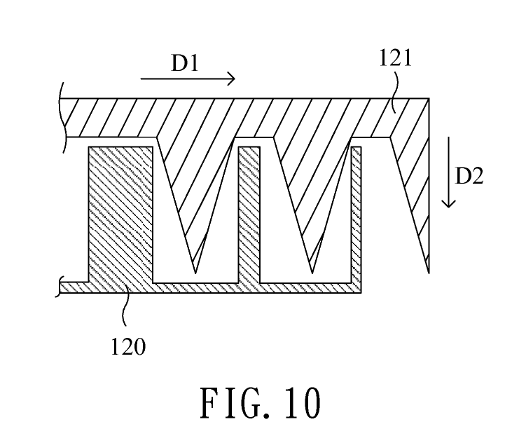

In a case that the width of a sensing cell 900 is much larger than the tip width of the finger or the control object, e.g. 2.5˜3 times or more, the uniform distribution of electrodes might be disadvantageous in the sensing capability of the sensing panel. Therefore, another exemplified configuration of the sensing electrodes 901 and 902 is proposed with reference to FIG. 10 for improving sensing capability when the width of the electrode juxtaposition zone is larger than the tip width of the control object. As shown, the sub-electrodes of the first sensing electrode 901 has decreasing effective area along the direction D1, while the sub-electrodes of the second sensing electrode 902 has decreasing effective area along the direction D2. Accordingly, once the finger or the control object moves on or over the panel along the direction D1 or the direction D2, the coupling capacitance is decreasing and thus can be further differentiated.

With the layout mentioned above, two-dimensional sensing matrix can be accomplished without forming an additional insulating layer, and equivalent capacitance between signal transmitting lines and signal receiving lines would become inessential. In practice, they can effectively function at capacitances C11˜Cmn of about 100 fF-10 pF. This shows that the invention achieves a considerable improvement as compared to prior arts which can only function effectively at 1-5 pF.

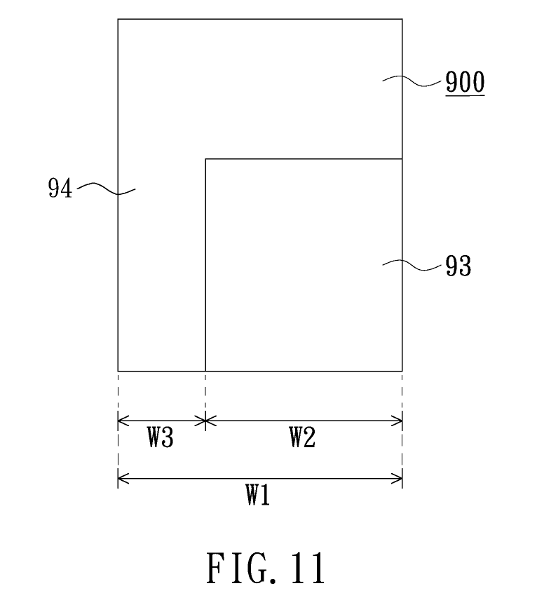

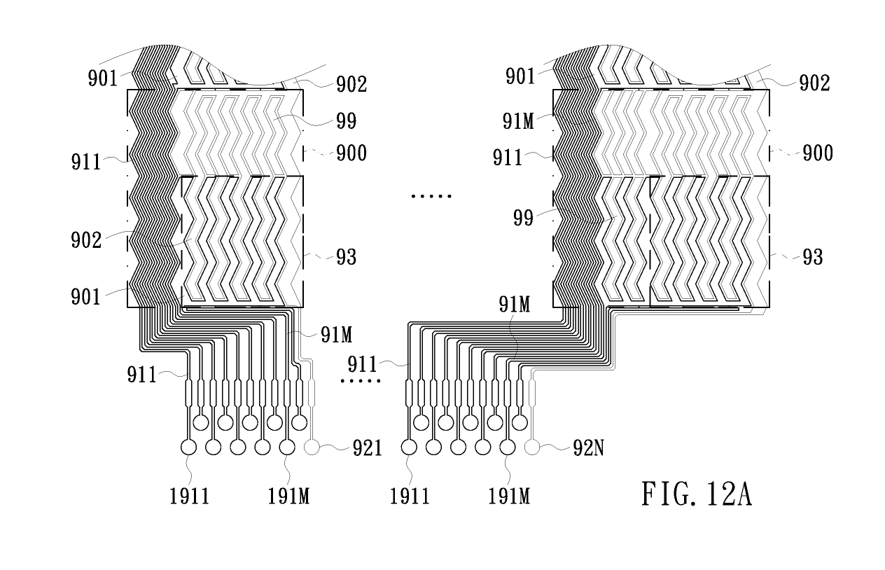

Since the sensing operation according to the present invention is performed for at least two lines, the resolution of the invention can be increased to two times at two dimensions, and the overall resolution can be increased to four times under the same wiring density. Therefore, in the control-point sensing panel according to the present invention, a satisfactory sensing effect can be achieved without allocating the electrode juxtaposition zones densely. In other words, the electrode juxtaposition zone 93 may be significantly smaller than the sensing cell 900, as shown in FIG. 11. For example, the area of the electrode juxtaposition zone 93 may occupy only ⅓˜½ the area of the sensing cell 900. Due to the reduction of the area of the electrode juxtaposition zones 93, the area 94 provided for wiring can be enlarged. Sufficient area of the wiring zone 94 allows relatively wide conductive wires to pass therethough, thereby avoiding undesired high resistance.

For assuring of satisfactory sensing capability, the width W2 of the electrode juxtaposition zone 93 and the width W3 of the wiring zone 94 preferably correlate to the tip width of the control object, e.g. a finger, a palm or a sensing pen. As known to those skilled in the art, different control objects are suitable for different panel sizes. For example, while palm sensing may be more suitable for large-size panels than small-size panels, pen sensing may be more suitable for small-size panels than large-size panels. Therefore, according to the present invention, once the tip width of the most suitable control object for a specified panel is determined, proper layout structures of the specified panel, including the width W1 of the sensing cell 900, the width W2 of the electrode juxtaposition zone 93 and the width W3 of the wiring zone 94, can be automatically derived.

According to an embodiment of the present invention, the width W2 of the electrode juxtaposition zone 93 is about 0.5˜4.5 times, preferably 1˜2 times, more preferably equal to, the tip width of the control object in contact with the sensing panel. For example, the tip width of a finger is typically about 4 mm, the tip width of a sensing pen for smaller-area sensing is typically about 1˜2 mm, and the tip width of a palm for larger-area sensing is about 20 mm. Therefore, for different panel sizes using respectively suitable control objects, preferable widths W2 of the electrode juxtaposition zone 93 can be derived. For example, the tip width of a finger in contact with the panel is 4 mm, so the width W2 of the electrode juxtaposition zone 93 may be 4˜8 mm, preferably 4 mm. In another example that the tip width of a sensing pen in contact with the panel is 1˜2 mm, the width W2 of the electrode juxtaposition zone 93 may be 4.5˜5 mm. As for the sensing panel typically with a palm having a tip width 20 mm, the width W2 of the electrode juxtaposition zone 93 may be 20 mm.

In another embodiment of the present invention, which may be alternative or additional to the above embodiment associated with the condition of the width W2 of the electrode juxtaposition zone 93, the width W3 of the wiring zone 94, i.e. the clearance between two adjacent electrode juxtaposition zone 93, is particularly designed to be, but not limited to, ½˜⅘ the tip width of the control object, and is preferably ½˜ 3/2 and more preferably equal or close to the tip width of the control object. For example, the tip width of a finger is typically about 4 mm, the tip width of a sensing pen for smaller-area sensing is typically about 1˜2 mm, and the tip width of a palm for larger-area sensing is about 20 mm. Therefore, for different panel sizes using respectively suitable control objects, preferable widths W3 of the wiring zones 94 can be derived. For example, the tip width of a finger in contact with the panel is 4 mm, so the width W3 of the wiring zone 94 can be 2˜5 mm, preferably 4 mm. In another example that the tip width of a sensing pen in contact with the panel is 1˜2 mm, the width W3 of the wiring zone 94 may be 1˜1.5 mm. As for the sensing panel typically with a palm having a tip width 20 mm, the width W3 of the wiring zone 94 may be about 20˜30 mm.

According to the present invention, it is preferred that the width W1 of the sensing cell 900 further correlates to the width W2 of the electrode juxtaposition zone 93, the width W3 of the wiring zone 94 and/or the tip width of the control object. For example, if the tip width of a finger in contact with the panel is 4 mm, the width W1 of the sensing cell 900 may be 6˜13 mm, preferably 8 mm. In another example that the tip width of a sensing pen in contact with the panel is 1˜2 mm, the width W1 of the sensing cell 900 may be 6 mm. As for the sensing panel typically with a palm having a tip width 20 mm, the width W1 of the sensing cell 900 may be about 40 mm. Generally speaking, the width W1 of the sensing cell 900 may be about 1.5˜2.5 times the tip width of the control object. Alternatively or additionally, the width W1 of the sensing cell 900 may be about 1⅜˜ 3/2 times the width W2 of the electrode juxtaposition zone 93. Accordingly, the area of the electrode juxtaposition zone 93 is about 64/169˜ 4/9 times the area of the sensing cell 900, in spite ⅓˜½ times is feasible.

In view of the foregoing, the electrode layout structure of a control-point sensing panel can be automatically designed, for example by way of a computer or any other suitable digital data processing device, by inputting a size of the substrate where the electrode layout structure is to be formed and the tip width of the suitable control object, e.g. finger, palm, sensing pen or any other suitable control object. In response to the input data, an electrode layout structure can be derived by a software program under preset conditions. The electrode layout structure includes M*N first sensing electrodes, M*N second sensing electrodes, a first signal input/output terminal set, and a second signal input/output terminal set. The first signal input/output terminal set includes M signal input/output terminals, each of which is at least electrically connected to N of the first sensing electrodes in parallel. The second signal input/output terminal set includes N signal input/output terminals, each of which is at least electrically connected to M of the second sensing electrodes in series. The first sensing electrodes and the second sensing electrodes are formed on the same plane, and form M*N electrode juxtaposition zones respectively in M*N sensing cells disposed at intersections of the first and second sensing electrodes. Each of the electrode juxtaposition zones in the electrode layout structure is preset to have a width range being 0.5˜4.5 times of the tip width of the control object. Alternatively or additionally, the clearance between adjacent two electrode juxtaposition zones in the electrode layout structure is preset to be about 0.5˜1.5 times of the tip width of the control object. Preferably, the area of the electrode juxtaposition zone in the electrode layout structure is further preset to be about ⅓˜½ times the area of the sensing cell 900. Furthermore, in the design algorithm of the electrode layout structure, if the derived width of the electrode juxtaposition zone is larger than the tip width of the control object, the configuration of sub-electrodes as shown in FIG. 10 will be adopted. That is, the sub-electrodes of the first sensing electrode 901 has decreasing effective area along the direction D1, while the sub-electrodes of the second sensing electrode 902 has decreasing effective area along the direction D2. Accordingly, once the finger or the control object moves on or over the panel along the direction D1 or the direction D2, the coupling capacitance is changing (decreasing). Therefore, the sensing panel according to the present invention exhibits better resolution capability and improved performance.

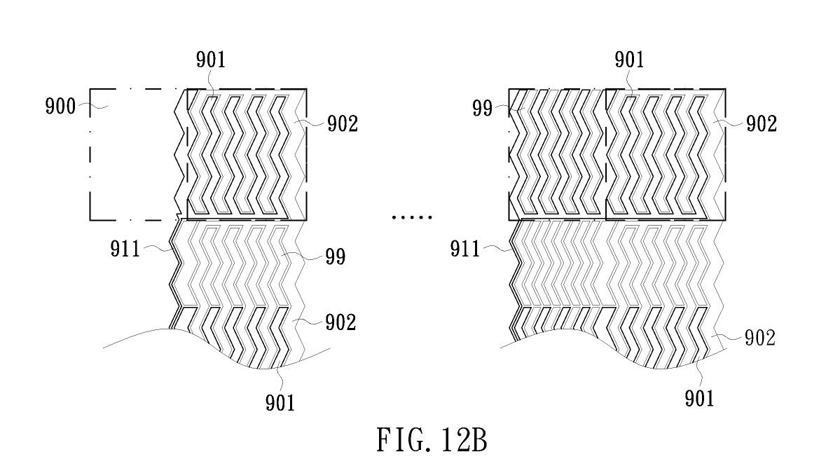

The sensing electrodes and wires, for example, can be implemented with transparent electrodes so as to be applicable to touch panel displays. For visual uniformity, transparent dummy wires 99 can be simultaneously formed as shown in FIG. 12A and 12B. The transparent electrodes can be defined by way of microlithography with masks. Nevertheless, since the width of the sensing cells and the width of the wires can be enlarged according to the present invention, the sensing electrodes and wires can also be formed by way of circuit printing processes at a reduced cost. If the touch panel does not have to be transparent, opaque wires can be printed, and no dummy wire is needed any more. Consequently, the material cost can be lowered.

The M input/output terminals 1911˜191M and the N input/output terminals 921˜92N described above are signal transmitting lines and signal receiving lines, respectively. Alternatively, the M input/output terminals 1911˜191M may serve as signal receiving lines, while the N input/output terminals 921˜92N may serve as signal transmitting lines.

In summary, the embodiments of the invention provide a method and device for sensing a control point, which are applied to a sensing panel. Position information of a control point can be accurately sensed by the method and device without increasing the number of signal lines. While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A control-point sensing panel for sensing a control point thereon in response to an action of a control object, comprising:
a substrate;
M*N first sensing electrodes formed on a surface of the substrate;
a first signal input/output terminal set including M signal input/output terminals, each of which is at least electrically connected to N of the first sensing electrodes in parallel;
M*N second sensing electrodes formed on the surface of the substrate; and
a second signal input/output terminal set including N signal input/output terminals, each of which is at least electrically connected to M of the second sensing electrodes;
wherein the first sensing electrodes and the second sensing electrodes are formed on the same plane, and form M*N electrode juxtaposition zones at intersections of the first and second sensing electrodes, and each of the electrode juxtaposition zones has a width being 0.5˜4.5 times the tip width of the control object.

2. The control-point sensing panel according to claim 1, wherein the M first sensing electrodes in the same column are coupled thereto M signal lines, respectively, which are grouped into a set of signal lines so that the control-point sensing panel includes N sets of signal lines, and wherein N signal lines corresponding to the N first sensing electrodes in the same row are electrically connected, in parallel, to a corresponding one of the M signal input/out terminals in the first signal input/output terminal set.

3. The control-point sensing panel according to claim 2, wherein the N sets of signal lines pass through respective columns of wiring zones, each of which is disposed between adjacent two of the electrode juxtaposition zones.

4. The control-point sensing panel according to claim 2, comprising a non-wiring region where dummy transparent wires are formed.

5. The control-point sensing panel according to claim 1, wherein the first sensing electrode and the second sensing electrode respectively include a plurality of sub-electrodes, and the sub-electrodes of the first sensing electrode and the sub-electrodes of the second sensing electrode are coplanar and alternately allocated in the electrode juxtaposition zones.

6. The control-point sensing panel according to claim 5, wherein at least one of the electrode juxtaposition zones has a width smaller than the tip width of the control object, and the effective area of the sub-electrodes of the first sensing electrode or the second sensing electrode decreases along a specified direction.

7. A control-point sensing panel for sensing a control point thereon in response to an action of a control object, comprising:
a substrate defined thereon M*N sensing cells;
M*N first sensing electrodes formed on a surface of the substrate;
a first signal input/output terminal set including M signal input/output terminals, each of which is at least electrically connected to N of the first sensing electrodes in parallel;
M*N second sensing electrodes formed on the surface of the substrate; and
a second signal input/output terminal set including N signal input/output terminals, each of which is at least electrically connected to M of the second sensing electrodes in series;
wherein the first sensing electrodes and the second sensing electrodes are formed on the same plane, and form M*N electrode juxtaposition zones in the M*N sensing cells at intersections of the first and second sensing electrodes, respectively, and each of the electrode juxtaposition zones has an area being ⅓˜½ times the area of the corresponding sensing cell.

8. The control-point sensing panel according to claim 7, further comprising N sets of M signal lines, wherein the M signal lines in each set respectively coupled to the M first sensing electrodes in the same column, and the N signal lines, each selected from one of the N sets and corresponding to one of the N first sensing electrodes in the same row, are electrically connected in parallel to a corresponding one of the M signal input/out terminals in the first signal input/output terminal set.

9. The control-point sensing panel according to claim 8, wherein the N sets of signal lines pass through respective columns of wiring zones, each of which is disposed between adjacent two of the electrode juxtaposition zones.

10. The control-point sensing panel according to claim 8, comprising a non-wiring region where dummy transparent wires are formed.

11. The control-point sensing panel according to claim 7, wherein the first sensing electrode and the second sensing electrode respectively include a plurality of sub-electrodes, and the sub-electrodes of the first sensing electrode and the sub-electrodes of the second sensing electrode are coplanar and alternately allocated in the electrode juxtaposition zones.

12. The control-point sensing panel according to claim 11, wherein at least one of the electrode juxtaposition zones has a width smaller than the tip width of the control object, and the effective area of the sub-electrodes of the first sensing electrode or the second sensing electrode decreases along a specified direction.

13. A control-point sensing panel for sensing a control point thereon in response to an action of a control object, comprising:
a substrate;
M*N first sensing electrodes formed on a surface of the substrate;
a first signal input/output terminal set including M signal input/output terminals, each of which is at least electrically connected to N of the first sensing electrodes in parallel;
M*N second sensing electrodes formed on the surface of the substrate; and
a second signal input/output terminal set including N signal input/output terminals, each of which is at least electrically connected to M of the second sensing electrodes in series;
wherein the first sensing electrodes and the second sensing electrodes are formed on the same plane, and form M*N electrode juxtaposition zones at intersections of the first and second sensing electrodes, and a clearance between every two adjacent ones of the electrode juxtaposition zones is 0.5˜1.5 times the tip width of the control object.

14. The control-point sensing panel according to claim 13, wherein the M first sensing electrodes in the same column are coupled thereto M signal lines, respectively, which are grouped into a set of signal lines so that the control-point sensing panel includes N sets of signal lines, and wherein N signal lines corresponding to the N first sensing electrodes in the same row are electrically connected, in parallel, to a corresponding one of the M signal input/out terminals in the first signal input/output terminal set.

15. The control-point sensing panel according to claim 14, wherein the N sets of signal lines pass through respective columns of wiring zones, each of which is disposed between adjacent two of the electrode juxtaposition zones.

16. The control-point sensing panel according to claim 14, comprising a non-wiring region where dummy transparent wires are formed.

17. The control-point sensing panel according to claim 13, wherein the first sensing electrode and the second sensing electrode respectively include a plurality of sub-electrodes, and the sub-electrodes of the first sensing electrode and the sub-electrodes of the second sensing electrode are coplanar and alternately allocated in the electrode juxtaposition zones.

18. The control-point sensing panel according to claim 17, wherein at least one of the electrode juxtaposition zones has a width smaller than the tip width of the control object, and the effective area of the sub-electrodes of the first sensing electrode or the second sensing electrode decreases along a specified direction.

19. A design method of a control-point sensing panel executable by a digital data processing device to define an electrode layout structure, the control-point sensing panel being used for sensing a control point thereon in response to an action of a control object, and the method comprising:
inputting a size of a substrate where the electrode layout structure is to be formed, and a tip width of the control object; and
acquiring the electrode layout structure according to the size of the substrate and the tip width of the control object, wherein the electrode layout structure includes M*N first sensing electrodes; M*N second sensing electrodes; a first signal input/output terminal set including M signal input/output terminals, each of which is at least electrically connected to N of the first sensing electrodes in parallel; and a second signal input/output terminal set including N signal input/output terminals, each of which is at least electrically connected to M of the second sensing electrodes in series;
wherein the first sensing electrodes and the second sensing electrodes are formed on the same plane, and form M*N electrode juxtaposition zones in M*N sensing cells at intersections of the first and second sensing electrodes, respectively.

20. The design method according to claim 19, wherein each of the electrode juxtaposition zones has a width being 0.5˜4.5 times the tip width of the control object.

21. The design method according to claim 19, wherein a clearance between every two adjacent ones of the electrode juxtaposition zones is 0.5˜1.5 times the tip width of the control object

22. The design method according to claim 19, wherein each of the electrode juxtaposition zones has an area being ⅓˜½ times the area of the corresponding sensing cell.

23. The design method according to claim 19, wherein at least one of the resulting electrode juxtaposition zones has a width smaller than the tip width of the control object, and the effective area of the sub-electrodes of the first sensing electrode or the second sensing electrode decreases along a specified direction.
